(19) United States
(12) Patent Application Publication
(10) Pub. No.: US 2024/0222711 A1
(43) Pub. Date: Jul. 4, 2024

(54) BATTERY WITH ELECTRODE HAVING ADDITIVE SHOWING IMPROVED ELECTRICAL PROPERTIES

(71) Applicant: UNIVERSITETET I OSLO, Oslo (NO)

(72) Inventors: Alok Mani TRIPATHI, Oslo (NO); Helmer FJELLVÅG, Oslo (NO)

(21) Appl. No.: 18/557,668

(22) PCT Filed: May 4, 2022
(86) PCT No.: PCT/EP2022/062052

§ 371 Date: Oct. 27, 2023

(30) Foreign Application Priority Data
May 4, 2021 (GB) 2106351.3

(51) Int. Cl. H01M 10/42; H01M 4/02; H01M 4/131; H01M 4/134; H01M 4/62; H01M 10/0525; H01M 10/0568; H01M 10/0569; H01M 50/417; H01M 50/429

(52) U.S. Cl. CPC H01M 10/4235; H01M 4/131; H01M 4/134; H01M 4/622; H01M 4/625; H01M 10/0525; H01M 10/0568; H01M 10/0569; H01M 50/417; H01M 50/4295; H01M 2004/027; H01M 2004/028; H01M 2220/20; H01M 2220/30; H01M 2300/0037

(57) ABSTRACT

The invention relates to a silicon material with an SEI stabilizing additive, suitable for use as an anode in a lithium-ion battery and to a method of producing said anode. The additive may improve the properties of a silicon anode in a lithium-ion battery such as the energy density, charge retention capacity, storage capacity and stability with respect to charge/discharge rate. The battery is suitable for use in electric appliances such as mobile phones and electronic vehicles.

### FIELD OF THE INVENTION

The invention relates to a silicon material with a stabilizing additive, suitable for use as an anode in a lithium-ion battery and to a method of producing said anode.

### BACKGROUND

Secondary lithium ion (Li-ion) batteries are widely used in electronic products, particularly in portable electronic products, for example mobile phones and electronic vehicles. Similarly, the Li-ion batteries have an immense role to play in electric transportation on road, sea and air. Li-ion batteries are suitable for such applications due to their high energy density, however they often have suboptimal cyclability. Typically, the energy density of a Li-ion battery degrades with repeat charge/discharge cycles, resulting in a reduced battery lifetime and poor commercial viability.

When a Li-ion battery is charged, Li⁺ ions from the cathode (positive electrode) flow through the electrolyte and are intercalated into the anode (negative electrode). During discharging, Li⁺ ions flow the opposite direction, from the anode and into the cathode. The successful and repeat intercalation and release of Li⁺ ions into and out of the electrodes, without damage to the electrodes, is therefore inherent to the battery's performance and lifetime.

A common choice for the anode material in Li-ion batteries is graphite due to its excellent electronic properties, low cost and light weight. However, carbon-based batteries are at risk of combustion when used for an extended period of time or at a high voltage.

US2020/058926A1 describes adding a very small amount (2 wt %) of a melamine-based additive to the cathode (positive electrode) of a battery cell, which also comprises, for example, a carbon-based anode. It is claimed that the melamine-based additive improves cathode safety due to its flame retardant properties. Another approach to improving safety could however include reducing the amount of carbon in the battery by finding a suitable alternative material for the anode.

Silicon (Si) is known to be such an alternative (Insertion Electrode Materials for Rechargeable Lithium Batteries, M. Winter, J. O. Besenhard, M. E. Spahr, and P. Novak in Adv. Mater. 1998, 10, No. 10). Silicon also has a significantly (˜10 times) higher theoretical capacity for Li⁺ intercalation than graphite when used as an active anode material in a Li-ion secondary battery. The reaction of silicon with lithium in an electrochemical cell results in an Li—Si alloy that has a theoretical capacity of 4,200 mAh/g for accommodation of 4.4 lithium per silicon atom. This is around an order of magnitude higher than the maximum capacity for graphite.

Furthermore, silicon is non-combustible and is thus a safer alternative to carbon-based anodes. However, silicon has relatively poor electronic properties and often requires processing to improve the physical properties of the anode. As such, silicon anodes often still contain a significant amount of carbon and typically undergo a curing stage during anode preparation to pyrolyze the carbon component (see for instance U.S. Pat. No. 10,427,982 and CN111048764A).

Diminishing capacity with cycle number is also an issue for Li-ion batteries with silicon anodes. One mechanism for degradation is swelling of the anode material. On Li⁺ intercalation, the silicon expands to accommodate the ions, which can result in a ˜300% increase in volume. After multiple cycles of expansion and contraction, battery operation can fail due to structural degradation of the electrode. It is known that anodes made from small particles of silicon are more able to withstand volume changes and thus anodes are often made of particles of crystalline silicon. WO2007/083155 indicates that the following silicon particle dimensions are most beneficial for withstanding the volume change: a minor dimension of about 0.08-0.5 μm, a major dimension of about 20-300 μm and an overall aspect ratio of about 100:1. Common methods of further mitigating the effects of volume change are i) adding polymeric binders to stabilize the particles, ii) adding a graphitized carbon coating to silicon materials and iii) limiting the potential window for battery operation.

A more specific problem that causes decreased performance of batteries with silicon anodes is degradation and continued growth of the solid electrolyte interface (SEI). During the first to fifth cycles of battery operation, an SEI is formed at the anode. The SEI is a passivation layer at the electrode that forms via the reaction of the electrolyte with the new electrode surface. There is an unavoidable loss in capacity in the first few cycles of operation associated with the formation of the SEI. Once the SEI is fully formed however, the system should be protected from further electrolyte decomposition and further capacity loss.

The SEI is a semi-solid structure and is therefore susceptible to cracking as the silicon anode expands and contracts during charge and discharge cycles. The SEI can therefore continue to grow during battery use by further reaction of the electrolyte with ‘fresh’ anode material between the cracks, resulting in further capacity loss. Structural instability of the SEI can also result in other problems such as incomplete discharge and sensitivity to high voltage. Stabilizing the SEI could therefore improve battery performance by mitigating the capacity loss during cycling, increasing the potential window for operation, and facilitating deep discharge.

Furthermore, it is also important to limit the capacity that is lost during SEI formation, as it reduces the initial, maximum capacity of the battery.

An attempt to stabilize the SEI of a silicon anode with an electrolyte additive is described in US2012/0129054. It is claimed that the diallyl carbonate electrolyte additive can promote the reaction between a non-aqueous solvent and the Li-ions in the electrolyte and thus form a stable SEI. This in turn might prevent side reactions of Li—Si alloys with the non-aqueous solvent resulting in a battery with a longer lifetime.

A different approach is described in CN111048764A whereby a silicon-carbon composite is presented. During synthesis of the anode, an organic additive is mixed with silicon particles and pyrolyzed in order to carbonize the additive and form a coating layer of graphitized carbon. The resultant composite material is claimed to improve stability of the SEI film and alleviate the anode volume change during operation, thus improving cyclability.

### SUMMARY OF THE INVENTION

The object of the present invention is to address the fading charge storage that occurs in Li-ion batteries with silicon anodes with increasing operation cycle.

The present invention describes an additive that improves battery performance. Here, an additive consisting of boric acid and/or a triazine-based compound is incorporated during the anode fabrication which improves SEI properties. The resultant battery has a higher discharge density as well as a lower capacity loss with cycle number than batteries without the additive. Furthermore, the amount of carbon in the anode of the present invention is decreased thus addressing the safety concerns of batteries with high carbon contents.

The present disclosure provides a composition comprising:
a silicon particle;
a polymeric binder;
optionally a carbonaceous material; and
an additive consisting of boric acid and/or a compound of formula (I)

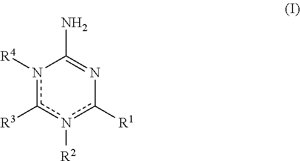

wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

The disclosure also provides an electrode formed from the composition of the disclosure.

The disclosure also provides an electrode comprising a composition comprising:
a silicon particle;
a polymeric binder;
optionally a carbonaceous material; and
an additive consisting of boric acid and/or a compound of formula (I), provided that when boric acid is present neither R¹ nor R³ denotes OH or ═O.

The disclosure also provides a battery cell comprising
a housing,
a battery core comprising a negative electrode (i.e. an anode), a positive electrode (i.e. a cathode), and a separator disposed between the cathode and the anode,
wherein the negative electrode comprises the electrode of the disclosure; and
an electrolyte operatively disposed between the negative electrode and the positive electrode, the electrolyte comprising at least one lithium salt and three non-aqueous solvent.

While the disclosure is amenable to various modifications and alternative forms, specifics thereof have been shown by way of example and will be described in detail.

It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description.

### BRIEF DESCRIPTION OF THE DRAWINGS

One or more embodiments will now be described by way of example only with reference to the accompanying drawings in which:

FIG. 1a is an X-ray diffraction pattern of crystalline silicon;

FIG. 1b is an X-ray diffraction pattern of amorphous silicon;

FIG. 2 is a comparison of battery capacity vs cycles number for batteries with and without additives;

FIGS. 3a-3e show the coulombic efficiency vs cycle number for batteries with and without additives;

FIGS. 4a-4h show in-situ Electrochemical Impedance Spectroscopy of electrodes with and without additives during charging and discharging in a half cell.

### DETAILED DESCRIPTION

The present disclosure relates to compositions that find particular use as an anode in a lithium-ion battery. Each of the components in the composition is described in more detail below:

### Silicon Particle

The composition of the disclosure comprises a silicon particle. The silicon particle acts as the charge sink for lithium ions when the composition is formed into an electrode. Consequently, the amount of silicon in the composition is usually relatively high.

Typically, the composition comprises from 40 wt % to 80 wt % silicon particle. Preferably, the composition comprised from 45 wt % to 75 wt % silicon particle, more preferably from 50 wt % to 70 wt % silicon particle, more preferably from 55 wt % to 65 wt % silicon particle, even more preferably from 57 to 63 wt % silicon particle.

The wt % of silicon particle represents the percent by weight of the composition excluding any dispersing medium, i.e. wt % solids.

The silicon particle may include an inorganic particle containing silicon as a main component, for instance not less than 35% by weight of the total silicon particle, preferably not less than 50% by weight of the total silicon particle, and more preferably not less than 70% by weight of the total silicon particle.

Suitable silicon particles include elemental silicon particles and/or lithium silicide (such as Li₂Si) particles.

Silicon particles can additionally or alternatively comprise SiOₓ, wherein generally x≤2. In some embodiments, for some SiOₓ particles, x≈1. For example, x can be about 0.9 to about 1.1, or about 0.99 to about 1.01. Within a body of SiOₓ particles, SiO₂ and/or Si domains may further exist. In some embodiments, the silicon particles can be considered “single phase” and not include any added conductive carbon (e.g., graphite).

Preferably, the silicon particle comprises crystalline silicon. Suitable types of crystalline silicon include monocrystalline silicon, polycrystalline silicon, microcrystalline silicon and nanocrystalline silicon.

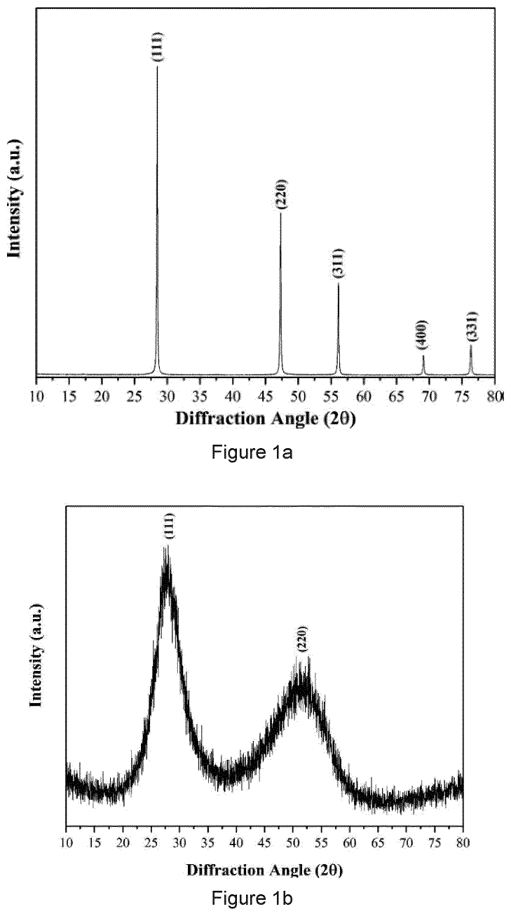

Crystalline silicon may be characterised by x-ray diffraction. Thus, crystalline silicon shows defined diffraction peaks (2θ angles) in line with FIG. 1a, as opposed to amorphous silicon which shows a broad spread of 2θ angles in line with FIG. 1b.

Preferably, the silicon particle is elemental silicon. Such particles may have a surface layer comprising oxygen and/or hydrogen atoms.

Preferably, the silicon particle is crystalline elemental silicon.

Preferably, the silicon particle is a nanoparticle.

The silicon particles may have an average (mean) particle diameter of less than about 1 μm, typically less than 500 nm, preferably less than 300 nm. For instance, the silicon particles may be about 1 nm to about 1 μm, or about 2 nm to about 500 nm, or about 5 nm to about 300 nm in some embodiments.

The average (mean) particle size of the silicon particles can be determined by Scanning Electron Microscopy (SEM). The average (mean) particle size can be calculated by measuring the diameter of (at least) 10 randomly chosen particles in an SEM image to determine an image mean; repeating this process to obtain an image mean for 7 random SEM images; disregarding the highest and lowest image means obtained in this way and calculating the average (mean) particle size from the mean average of the remaining 5 image means. In the case that the particles are not perfectly spherical, the largest particle diameter should be measured. If the silicon particles are coalesced together, the particle diameter is taken as the diameter of what appears to be an individual particle within the coalesced structure.

### Polymeric Binder

The role of the polymeric binder is to provide mechanical strength to the composition over the current collector, when it is formed into an electrode. Its primary role is therefore structural, and a range of suitable polymeric binders soluble in aqueous medium can be used providing they do not interfere with or are detrimental to the electrical properties of the composition.

Typically, the composition comprises from 5 wt % to 25 wt % polymeric binder. Preferably, the composition comprised from 5 wt % to 20 wt % polymeric binder, preferably from 10 wt % to 20 wt % polymeric binder, most preferably about 15 wt % polymeric binder.

The wt % of polymeric binder represents the percent by weight of the composition excluding any dispersing medium, i.e., wt % solids.

Suitable polymeric binders may be selected from polyethylene oxide (PEO), an ethylene propylene diene monomer (EPDM) rubber, carboxymethyl-group-containing cellulose ether, styrene-butadiene rubber (SBR), styrene-butadiene rubber carboxymethyl cellulose (SBR-CMC), polyacrylic acid (PAA), Li-PAA, Na-PAA, Na-alginate, cross-linked polyacrylic acid-polyethylenimine, polyimide, polyvinyl alcohol (PVA), nitrile butadiene rubber (NBR), or polyacrylonitrile (PAN).

Preferred polymeric binders may be selected from carboxymethyl-group-containing cellulose ether, PVA or Na-alginates, with carboxymethyl-group-containing cellulose ether being particularly preferred.

The carboxymethyl-group-containing cellulose ether may include, for example, a carboxymethyl cellulose (CMC), an alkyl carboxymethyl cellulose (such as a methyl carboxymethyl cellulose), and a hydroxyalkyl carboxymethyl cellulose (such as a hydroxyethyl carboxymethyl cellulose or a hydroxypropyl carboxymethyl cellulose). These carboxymethyl-group-containing cellulose ethers may be used alone or in combination.

Carboxymethyl cellulose is particularly preferred as the polymeric binder.

The CMC has any average degree of etherification (an average degree of etherification of carboxymethyl group) (or an average degree of substitution, DS) that can express an appropriate water solubility and viscosity in water to improve the coating property (coatability) of the composition. The average degree of etherification may be selected from a wide range of about 0.1 to 3 and may be preferably about 0.2 to 2, and more preferably about 0.5 to 1.2.

The term “average degree of substitution” means an average of a substitution degree (a substitution rate, particularly a substitution degree of carboxymethyl groups which may form salts) with respect to hydroxyl groups on 2-, 3- and 6-positions of a glucose unit constituting a cellulose, and the maximum value of the average degree of substitution is 3.

The carboxymethyl-group-containing cellulose ether (particularly the CMC) may form a salt. The salt may include, for example, a monovalent metal salt such as an alkali metal salt (e.g., a lithium salt, a sodium salt, a potassium salt, a rubidium salt, and a cesium salt), a divalent metal salt such as an alkaline earth metal salt (e.g., a calcium salt and a magnesium salt), a quaternary ammonium salt, an amine salt, a substituted amine salt, or double salts thereof.

The salt (CMC salt) preferably includes an alkali metal salt such as a sodium salt, a quaternary ammonium salt, particularly an alkali metal salt such as a sodium salt.

The polymeric binder is typically dispersible in an aqueous medium.

### Carbonaceous Material

The role of the optional carbonaceous material is to improve the electronic conductivity between the silicon particles.

Typically, the composition comprises from 0 wt % to 25 wt % carbonaceous material. Preferably, the composition comprised from 5 wt % to 20 wt % carbonaceous material, more preferably from 5 wt % to 15 wt % carbonaceous material.

The wt % of carbonaceous material represents the percent by weight of the composition excluding any dispersing medium, i.e., wt % solids.

The carbonaceous (or carbon) material may include, for example, a graphite, a mesocarbon microbead (MCMB), a pitch-based carbon, and a coke powder. These carbonaceous materials may be used alone or in combination. Among these carbonaceous materials, graphite is preferred in view of excellent charge-discharge characteristics, with highly oriented pyrolytic graphite (HOPG) even more preferred.

### Additive

Typical silicon-based electrode materials in Li-batteries comprise a blend of silicon particles, polymeric binder and a carbonaceous material. It has surprisingly been found that the electrical properties of the silicon can be significantly improved by the use of an additive consisting of a compound of formula (I) and/or boric acid. The presence of the additive stabilises the solid electrolyte interface, resulting in improved energy density and capacity retention even after hundreds of charge-discharge cycles.

Specifically, the composition of the disclosure contains an additive consisting of boric acid and/or a compound of formula (I):

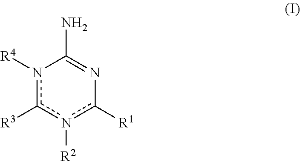

wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

In some embodiments, the composition of the disclosure comprises an additive consisting of boric acid.

Preferably, the composition of the disclosure comprises an additive consisting of a compound of formula (I), optionally present together with boric acid, provided that when boric acid is present neither R¹ nor R³ denotes OH or ═O.

In preferred compounds of formula (I), boric acid is present when R¹ and R³ both denote H.

In preferred compounds of formula (I),
R³ denotes H or NH₂.

In preferred compounds of formula (I),
R³ denotes NH₂.

In preferred compounds of formula (I),
R¹ denotes NH₂,
R³ denotes NH₂, and
boric acid is optionally present.

In preferred compounds of formula (I),
R¹ denotes NH₂,
R³ denotes NH₂, and
boric acid is optionally present as one or two stoichiometric equivalents.

In preferred compounds of formula (I),
R¹ denotes NH₂, and
R³ denotes NH₂.

In preferred compounds of formula (I),
R¹ denotes OH, and
R³ denotes NH₂.

In preferred compounds of formula (I),
R¹ denotes ═O,
R² denotes H, and
R³ denotes H.

Preferred additives are selected from:
2-amino-1,3,5-triazine in combination with boric acid, preferably in a 1:1 or 1:2 ratio

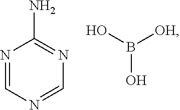

melamine

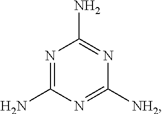

melamine in combination with boric acid, preferably in a 1:2 ratio

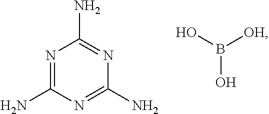

melamine diborate

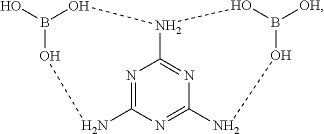

4,6-diamino-2-hydroxy-1,3,5-triazine

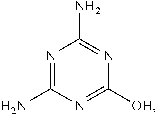

and
4-amino-2-hydroxy-1,3,5-triazine

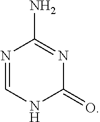

Particularly preferred additives are selected from:
melamine,
melamine in combination with boric acid, preferably in a 1:2 ratio
melamine diborate
4,6-diamino-2-hydroxy-1,3,5-triazine, and
4-amino-2-hydroxy-1,3,5-triazine.

The ratio of compound of formula (I) (e.g., melamine) and boric acid is expressed as a stoichiometric ratio.

Typically, the composition comprises from 5 wt % to 25 wt % additive (i.e., boric acid and/or compound of formula (I)). Preferably, the composition comprises from 7 wt % to 25 wt % additive (i.e., boric acid and/or compound of formula (I)), more preferably, the composition comprises from 10 wt % to 20 wt % additive (boric acid and/or compound of formula (I)).

The wt % of additive (i.e., boric acid and/or compound of formula (I)) represents the percent by weight of the composition excluding any dispersing medium, i.e., wt % solids.

Thus, the composition preferably comprises (as wt % solids):
from 40 wt % to 80 wt % silicon particle,
from 5 wt % to 25 wt % polymeric binder,
from 0 wt % to 25 wt % carbonaceous material,
from 5 wt % to 25 wt % additive consisting of boric acid and/or compound of formula (I).

Preferably, the composition preferably comprises (as wt % solids):
from 45 wt % to 75 wt % silicon particle,
from 5 wt % to 20 wt % polymeric binder,
from 5 wt % to 20 wt % carbonaceous material,
from 7 wt % to 25 wt % additive consisting of boric acid and/or compound of formula (I).

More preferably, the composition comprises (as wt % solids):
from 50 wt % to 70 wt % silicon particle,
from 10 wt % to 20 wt % polymeric binder,
from 5 wt % to 15 wt % carbonaceous material,
from 10 wt % to 20 wt % additive consisting of boric acid and/or compound of formula (I).

### Electrode

The composition of the disclosure may be in the form of a dispersion or slurry which can then be formed into an electrode.

The disclosure therefore also relates to an electrode comprising the composition of the disclosure.

Specifically, the electrode of the disclosure comprises (and preferably at the preferred amounts specified above)
a silicon particle;
a polymeric binder;
optionally a carbonaceous material; and
an additive consisting of boric acid and/or a compound of formula (I), provided that when boric acid is present neither R¹ nor R³ denotes OH or ═O.

An exemplary method for forming an electrode from the composition of the disclosure comprises:
dispersing the composition in a dispersing solvent,
forming the dispersed composition into an electrode, and
removing the dispersing solvent.

The dispersing solvent used to form the dispersion should be compatible with the polymeric binder, capable of dispersing/dissolving the compound of formula (I) (when present), and relatively easy to remove.

Preferably, the electrode of the disclosure is formed using a method that avoids polymerisation of the compound of formula (I). In other words, the electrode of the disclosure preferably contains the compound of formula (I) in non-polymerised form.

A dispersing solvent is compatible with the polymeric binder when it allows the binder to disperse or dissolve such that it is capable of thoroughly intermixing with and forming a network around the other components. This allows the polymeric binder to provide mechanical strength to the electrode on removal of the solvent.

When the compound of formula (I) is dispersed at the molecular level or dissolved in the solvent, it is more capable of coating the silicon particle and allowing an efficient SEI to be formed.

The dispersing solvent is typically removed by drying, optionally by heating. Any heating should not degrade the compound of formula (I) (when present) and/or the polymeric binder. Consequently, the dispersing solvent should have a relatively high vapour pressure, and/or a low boiling point.

Suitable dispersing solvents may be protic or aprotic, and include water, methanol, ethanol, isopropanol, acetone, tetrahydrofuran, diethyl ether, ethyl acetate A particularly preferred dispersing solvent is water.

Water is favourable as it is non-toxic, capable of dissolving the compound of formula (I), and compatible with the preferred polymeric binders disclosed herein, particularly carboxymethyl cellulose salts.

A preferred method for forming an electrode from the composition of the disclosure comprises:
dispersing the composition in water, for instance by stirring for at least 2 hours preferably for 3 to 8 hours,
forming the dispersed composition into an electrode, and
removing the solvent by heating for instance at a temperature of from 60° C. to 95° C., preferably at a temperature of from 75° C. to 85° C.

The dispersing step is typically carried out at room temperature (i.e. without heating).

The step of forming the dispersed composition into an electrode comprises casting the composition. However, any suitable process may be used.

The process used in the forming step may depend on the viscosity of the dispersed composition. If the viscosity is high enough, the dispersed composition may be paste-like, in which case it can simply be pressed into the shape of an electrode.

Other forming steps are also possible, for instance spin coating, casting, spreading or the like.

Typically, the forming step will comprise applying the composition to a current collector, which is a conductive material that connects the electrode to the remainder of the circuit. Suitable materials are metals such as copper or aluminium, preferably copper.

It may be difficult to ensure complete dispersion of the components in a viscous paste. The method for forming the electrode may therefore comprise an optional step of removing solvent from the dispersed composition to increase its viscosity prior to forming the dispersed composition into the electrode. This allows complete dispersion of the components while also ensuring the ideal viscosity for electrode formation.

The electrodes of the disclosure contain a lower amount of carbonaceous material in comparison to typical silicon-based electrodes. This reduces the risk of combustion of the electrode during commercial application.

### Battery

The electrode formed from the composition of the disclosure finds particular use as an anode in a lithium-ion battery.

The disclosure therefore also relates to a lithium ion battery comprising the electrode of the disclosure.

Preferably, the disclosure relates to a battery cell comprising
a housing,
a battery core comprising a negative electrode (i.e., an anode), a positive electrode (i.e., a cathode), and a separator disposed between the negative electrode and the positive electrode,
wherein the negative electrode comprises the electrode of the disclosure; and
an electrolyte operatively disposed between the negative electrode and the positive electrode, the electrolyte comprising at least one lithium salt and a non-aqueous solvent.

The housing may be made from any suitable material compatible with the battery core. Suitable materials include aluminium.

The separator is usually a microporous polymeric membrane typically comprising an inert polymer. Suitable polymeric materials for the microporous separator are selected from polyolefin (such as polyethylene, polypropylene or a mixture thereof), polyethylene terephthalate (PET), polyvinylidene fluoride (PVDF), a cellulose, and nylon. The separator may also be a microporous ceramic material, such as microporous aluminium oxide or lithiated zeolite-type oxide.

Preferably, the separator comprises a cellulose or a polyolefin.

The cathode is formed from an appropriate electrically conductive material known to skilled artisans, and can be formed in a foil or grid shape.

Suitable materials include metal oxides such as lithium cobalt oxide, lithium manganese oxide, lithium iron phosphate, lithium nickel manganese cobalt oxide, or lithium nickel cobalt aluminium oxide. These metal oxides are capable of releasably intercalating lithium allowing it to be released during charging of the battery cell, and taken up during discharge of the battery cell.

The electrolyte conducts lithium ions between anode and cathode, for example during charging or discharging the battery cell. The electrolyte comprises one or more solvents, and one or more lithium salts dissolved in the one or more solvents.

Suitable non-aqueous solvents can include cyclic carbonates (ethylene carbonate, propylene carbonate, butylene carbonate), fluorinated cyclic carbonates (fluoroethylene carbonate (FEC)), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,3-dimethoxypropane, 1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof.

Preferably, the non-aqueous solvent is selected from dimethyl carbonate, diethyl carbonate, ethylmethyl carbonate, ethylene carbonate, fluoroethylene carbonate, or mixtures thereof.

Preferred non-aqueous solvent mixtures include:
dimethyl carbonate, ethylene carbonate, and fluoroethylene carbonate;
diethyl carbonate, ethylene carbonate, and fluoroethylene carbonate;
ethylmethyl carbonate, ethylene carbonate, and fluoroethylene carbonate; and
dimethyl carbonate, diethyl carbonate, ethylene carbonate, and fluoroethylene carbonate.

Typically, the fluoroethylene carbonate is added in a relatively small amount, for instance from 5 to 15 wt % and preferably about 10 wt % of the overall solvent.

Particularly preferred non-aqueous solvent mixtures include:
dimethyl carbonate:ethylene carbonate (1:1 w/w) and from 5 to 15 wt % fluoroethylene carbonate;
diethyl carbonate:ethylene carbonate (1:1 w/w), and fluoroethylene carbonate;
ethylmethyl carbonate:ethylene carbonate (1:1 w/w), and from 5 to 15 wt % fluoroethylene carbonate; and
dimethyl carbonate:diethyl carbonate:ethylene carbonate (1:1:1 w/w), and from 5 to 15 wt % fluoroethylene carbonate.

A non-limiting list of lithium salts that can be dissolved in the organic solvent(s) to form the non-aqueous liquid electrolyte solution include LiCO₄, LiAlCl₄, LII, LiBr, LiSCN, LiBF₄, LiB(C₆H₅)₄ LiAsF₆, LiCF₃SO₃, LiN(CF₃SO₂)₂, LiN(FSO₂)₂, LiPF₆, and mixtures thereof.

Preferably, the lithium salt is selected from LiPF₆.

Typically, the lithium salt is present in a concentration of from 0.2 to 4 M, preferably from 0.5 to 2 M, for instance about 1 M.

The battery cell generally operates by reversibly passing lithium ions between anode and cathode. Lithium ions move from cathode to anode while charging, and move from anode to cathode while discharging. At the beginning of a discharge, the anode contains a high concentration of intercalated/alloyed lithium ions while the cathode is relatively depleted, and establishing a closed external circuit between anode and cathode under such circumstances causes intercalated/alloyed lithium ions to be extracted from anode. The extracted lithium atoms are split into lithium ions and electrons as they leave an intercalation/alloying host at an electrode-electrolyte interface. The lithium ions are carried through the micropores of separator from anode to cathode by the ionically conductive electrolyte while, at the same time, the electrons are transmitted through the external circuit to which the battery cell is connected from anode to cathode to balance the overall electrochemical cell. This flow of electrons through the external circuit can be harnessed and fed to a load device until the level of intercalated/alloyed lithium in the negative electrode falls below a workable level or the need for power ceases.

During use, the battery cell shows moderate loss in capacity during the first few cycles. However, this is very typical of all lithium ion batteries and is thought to be caused by the intercalation of the lithium ions into the silicon structure. This causes significant expansion and rearrangement of the silicon framework as the SEI is being formed.

Surprisingly, the battery cell of the disclosure shows reduced capacity loss during the formation of the SEI. Moreover, after SEI formation, the charge-discharge efficiency is very high with significantly reduced capacity loss when compared to lithium ion batteries based on silicon electrodes without an additive according to the disclosure. The battery cell of the disclosure also shows that the SEI formed during the first 5 charge/discharge cycles is surprisingly more stable than for batteries that do not comprise an additive according to the disclosure.

The battery cell of the disclosure therefore shows improved cyclability, improved energy density, improved capacity retention due to an extended window of charge-discharge and a stable interface at the silicon electrode surface. Without wishing to be bound by theory, these advantages are thought to arise due to additives according to the disclosure stabilising the SEI of the silicon electrode. A stable SEI further minimizes electrolyte breakdown and irreversible lithium loss in the cell. This leads to an improved Coulombic efficiency of the cell. The stabilisation of the SEI may be due to the electron rich nature of the additive and presence of lone pairs, which in combination mitigate the amount of electron leakage into the electrolyte.

Typically, the battery cell (or the lithium ion battery) of the disclosure has a charge capacity after 100 cycles of at least 1000 mAh/g, preferably at least 1500 mAh/g, more preferably at least 1750 mAh/g, more preferably at least 2000 mAh/g, more preferably at least 2150 mAh/g, more preferably at least 2250 mAh/g, more preferably at least 2350 mAh/g, more preferably at least 2400 mAh/g.

Typically, the battery cell (or the lithium ion battery) of the disclosure is capable of retaining this charge capacity when charging at C/10, preferably when charging at C/5.

The disclosure of the present invention relates to a lithium ion battery suitable for use in electronic appliances. Suitable electronic appliances could be portable electronic appliances with removable batteries such as mobile phones or remote controls, or portable electronic appliances with permanent batteries such an electric vehicles e.g. a bicycle, scooter or car.

The disclosure therefore also relates to an electronic appliance comprising the battery cell of the disclosure. Preferably the electronic appliance is an electric vehicle such as a bicycle, a scooter, a boat, a truck or a car; a power tool such as a drill, saw, screwdriver, multitool, strimmer, lawnmower, hedge trimmer, or sander; a household appliance such as an electric shaver, a toothbrush, a vacuum cleaner; portable computer such as a laptop, tablet, mobile phone or the like.

The use of boric and and/or a compound of formula (I) improves the properties of the silicon particle when used in a lithium ion battery.

The disclosure therefore also relates to the use of boric acid and/or an compound of formula (I) to increase the energy density of a silicon electrode in a lithium ion battery.

The disclosure also relates to the use of boric acid and/or an compound of formula (I) to increase the charge retention capacity of a silicon electrode in a lithium ion battery.

The disclosure also relates to the use of boric acid and/or a compound of formula (I) to increase the storage capacity of a silicon electrode in a lithium ion battery.

This disclosure also relates to the use of boric acid and/or a compound of formula (I) to increase the stability of a silicon electrode in a lithium ion battery with respect to charge/discharge rate.

This disclosure also relates to the use of boric acid and/or a compound of formula (I) to increase the discharge rate of a silicon anode.

This disclosure also relates to the use of boric acid and/or a compound of formula (I) to improve the stability of the SEI (solid electrolyte interface) of a silicon electrode in a lithium ion battery, for example, for the prevention of continued SEI formation or for the prevention of SEI thickening with cycle number.

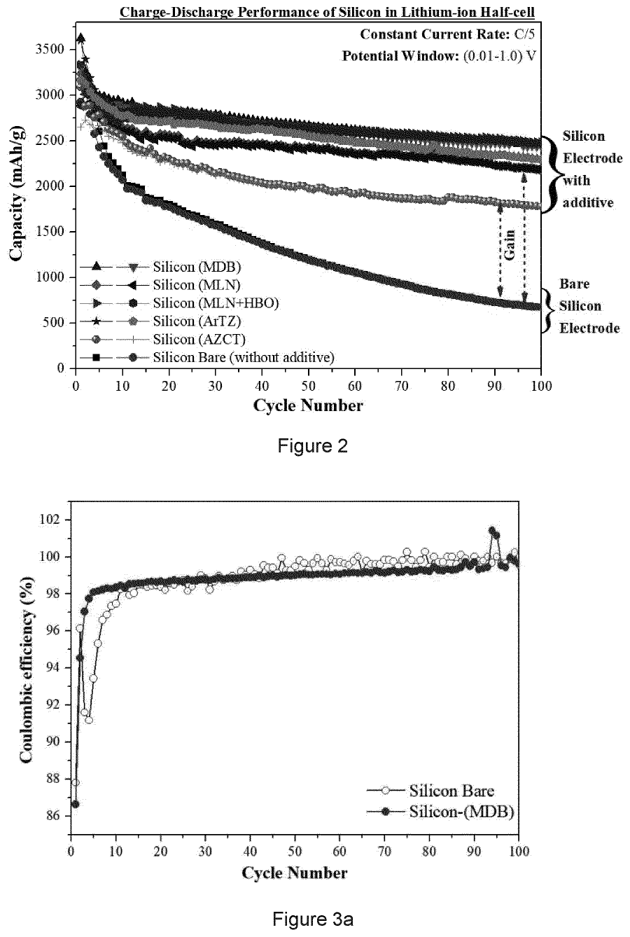

FIG. 2 shows the improvement in battery capacity vs cycle number for Li-ion batteries with an additive to the silicon anode and without an additive.

The listing or discussion of an apparently prior published document in this specification should not necessarily be taken as an acknowledgement that the document is part of the state of the art or is common general knowledge.

Preferences, options and embodiments for a given aspect, feature or parameter of the invention should, unless the context indicates otherwise, be regarded as having been disclosed in combination with any and all preferences, options and embodiments for all other aspects, features and parameters of the invention. This is especially true for the description of the dry composition and all its features, which may readily be part of the final dry composition obtained by the method as described herein. Embodiments and features of the present invention are also outlined in the following items.

### Items

A1. A composition comprising:
a silicon particle;
a polymeric binder;
optionally a carbonaceous material; and
an additive consisting of boric acid and/or a compound of formula (I)

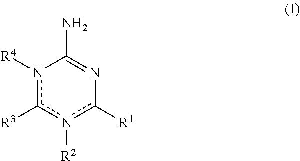

wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

A2. The composition according to item A1, wherein the composition comprises a compound of formula (I), wherein the compound of formula (I) may optionally be present together with boric acid, provided that when boric acid is present neither R¹ nor R³ denotes OH or ═O.

A3. The composition according to item A1, wherein the composition comprises an additive consisting of a compound of formula (I), optionally be present together with boric acid, provided that when boric acid is present neither R¹ nor R³ denotes OH or ═O.

A4. The composition of any of items A1 to A3, wherein boric acid is present when R¹ and R³ both denote H.

A5. The composition of any of item 1 A1-A4, wherein R³ denotes H or NH₂.

A6. The composition of any of items A1-A5, wherein the compound of formula (I) is selected from:
melamine,
melamine and boric acid, preferably in a 1:2 ratio,
melamine diborate,
4,6-diamino-2-hydroxy-1,3,5-triazine, and
4-amino-2-hydroxy-1,3,5-triazine.

A7. The composition of any of items A1-A6, wherein the silicon particle comprises crystalline silicon.

A8. The composition of any of items A1-A7, wherein the silicon particle comprises elemental silicon.

A9. The composition of any of items A1-A8, wherein the polymeric binder comprises carboxymethyl cellulose, particularly a sodium salt of carboxymethyl cellulose.

A10. The composition of any of items A1-A9, wherein the carbonaceous material comprises graphite.

A11. The composition of any of items A1 or A7 to A10, wherein the additive consists of boric acid.

A12. The composition of any of items A1-A11, comprising
from 40 wt % to 80 wt % silicon particle,
from 5 wt % to 25 wt % polymeric binder,
from 0 wt % to 25 wt % carbonaceous material, and
from 5 wt % to 25 wt % additive consisting of boric acid and/or compound of formula (I).

A13. The composition of any of items A1-A12, comprising
from 40 wt % to 80 wt % silicon particle,
from 5 wt % to 25 wt % polymeric binder,
from 0 wt % to 25 wt % carbonaceous material, and
from 7 wt % to 25 wt % additive consisting of boric acid and/or compound of formula (I).

B1. An electrode comprising the composition of any of items A1-A13.

C1. A lithium ion battery comprising the electrode of item B1.

D1. A battery cell comprising
a housing,
a battery core comprising a negative electrode, a positive electrode, and a separator disposed between the negative electrode and the positive electrode,
wherein the negative electrode comprises the electrode of item B1; and
an electrolyte operatively disposed between the negative electrode and the positive electrode, the electrolyte comprising at least one lithium salt and a non-aqueous solvent.

D2. The battery cell of item D1, wherein the electrolyte comprises
a non-aqueous solvent mixture selected from:
dimethyl carbonate, ethylene carbonate, and fluoroethylene carbonate;
diethyl carbonate, ethylene carbonate, and fluoroethylene carbonate;
ethylmethyl carbonate, ethylene carbonate, and fluoroethylene carbonate; and
dimethyl carbonate, diethyl carbonate, ethylene carbonate, and fluoroethylene carbonate; and
a lithium salt comprising LiPF₆.

D3. The lithium ion battery of item C1 or the battery cell of item D1 or item D2, wherein the lithium ion battery or battery cell has a charge capacity after 100 cycles of at least 1000 mAh/g, preferably at least 1500 mAh/g, more preferably at least 1750 mAh/g, more preferably at least 2000 mAh/g, more preferably at least 2150 mAh/g, more preferably at least 2250 mAh/g, more preferably at least 2350 mAh/g, more preferably at least 2400 mAh/g.

E1. Use of boric acid and/or an compound of formula (I) to increase the energy density, charge retention capacity and/or storage capacity of a silicon electrode in a lithium ion battery,

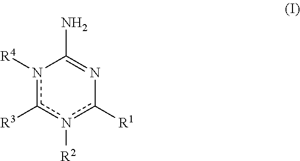

wherein

R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

E2. Use of boric acid and/or a compound of formula (I) for improving the SEI stability of a silicon electrode in a lithium ion battery

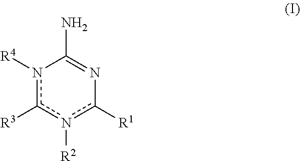

wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

E3. Use of boric acid and/or a compound of formula (I) for preventing continued growth and/or thickening of the SEI of a silicon electrode in a lithium ion battery

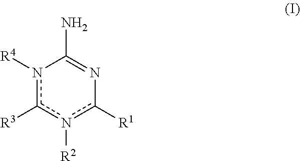

wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

E4. Use of any of items E1 to E3, wherein the use is of a compound of formula (I), optionally present together with boric acid, provided that when boric acid is present neither R¹ nor R³ denotes OH or ═O.

### EXAMPLES

### Example 1

i) Making a silicon+additive anode by dispersing 60% crystalline silicon nanoparticles (Sigma Aldrich, ‘Silicon nanopowder’, product number: 633097), 15% carboxymethyl cellulose sodium salt binder (Sigma Aldrich, ‘Sodium carboxymethyl cellulose’, product number: 419338), 10% graphite source (Alfa Aesar, ‘Carbon black, Super P’), product number: H30253) and 15% additive in 100 mL water whereby all quantities are by weight %
ii) Stirring or mixing the dispersion for 5 hours to form a slurry
iii) Spreading the slurry on a copper substrate to produce a film
iv) Heating the substrate and the film to 80° C. under vacuum to remove the water and create a solid electrode

The silicon+boric acid and/or additive anode is then used to form a battery cell with a lithium counter and reference electrode, and an LP30 electrolyte (Sigma Aldrich, ‘Lithium hexafluorophosphate solution, product number: 746711) with 10 wt % of fluoroethylene carbonate (FEC) electrolyte additive (Sigma Aldrich, ‘Fluoroethylene carbonate’, product number: 901686).

The LP30 electrolyte is 1 M LiPF₆ in ethylene carbonate and dimethyl carbonate (1:1 w/w) and the structure of FEC is shown below:

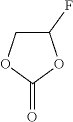

### Example 1a

The anode and battery of Example 1 with 15 wt % melamine diborate (MDB) as the additive.

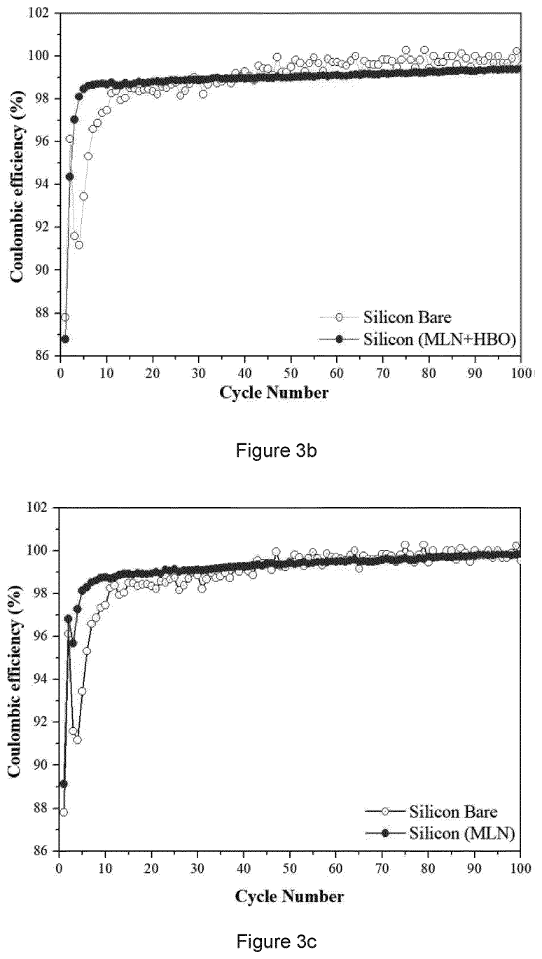

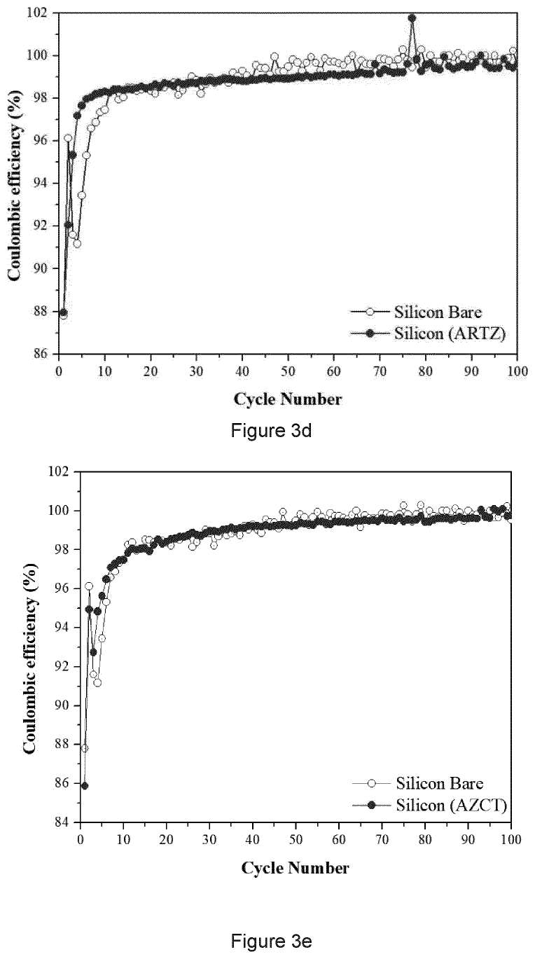

FIG. 3a shows a comparison of the battery's coulombic efficiency vs. cycle number for a silicon anode without an additive and for a silicon anode with melamine-diborate (MDB) as the additive.

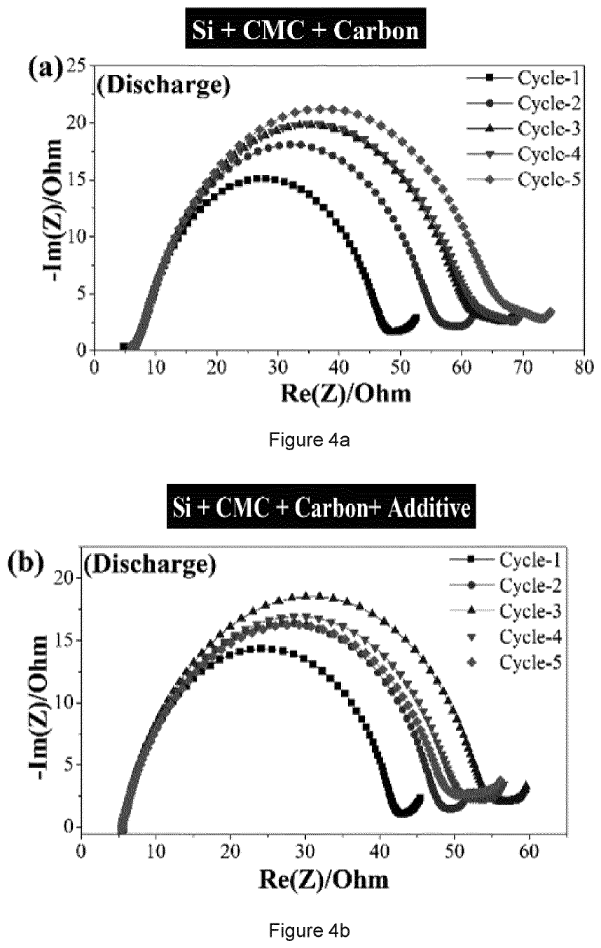

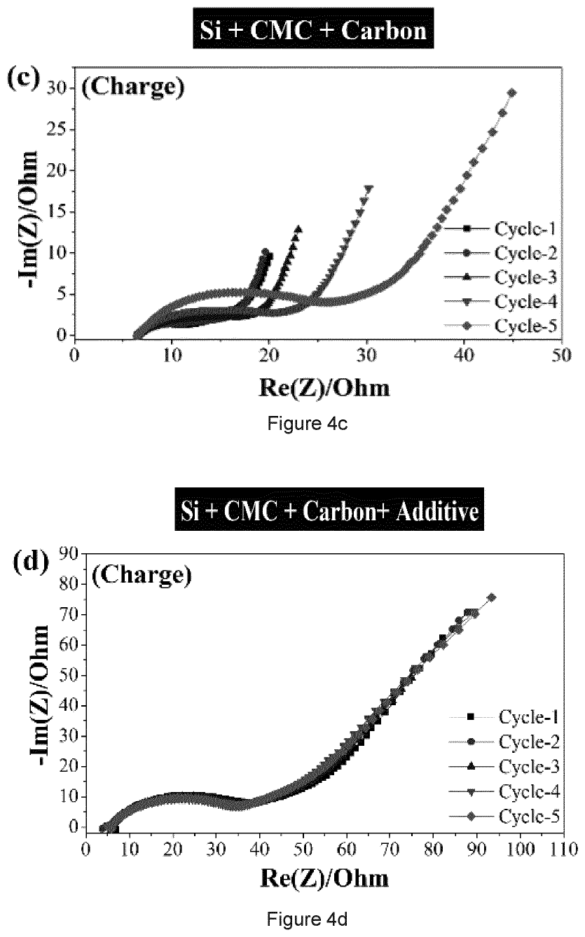

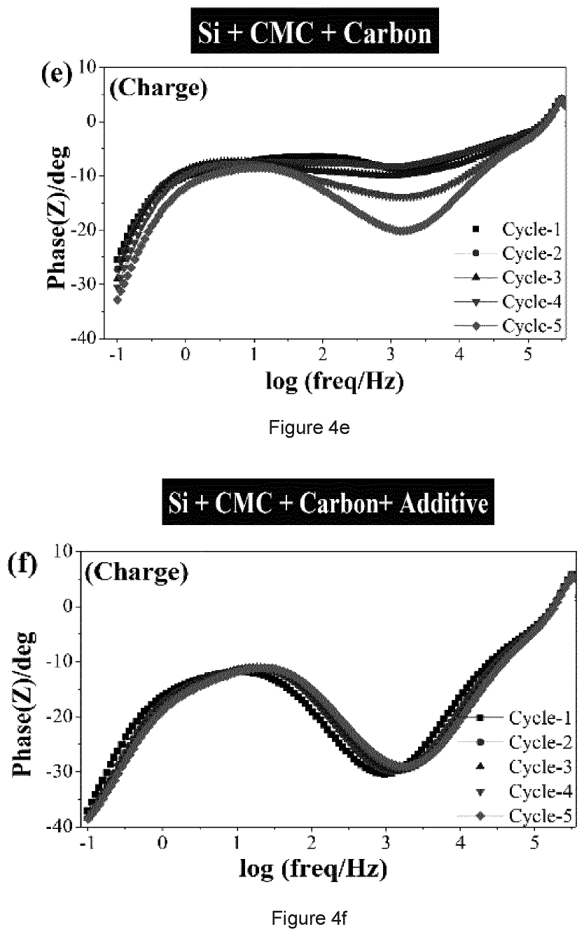

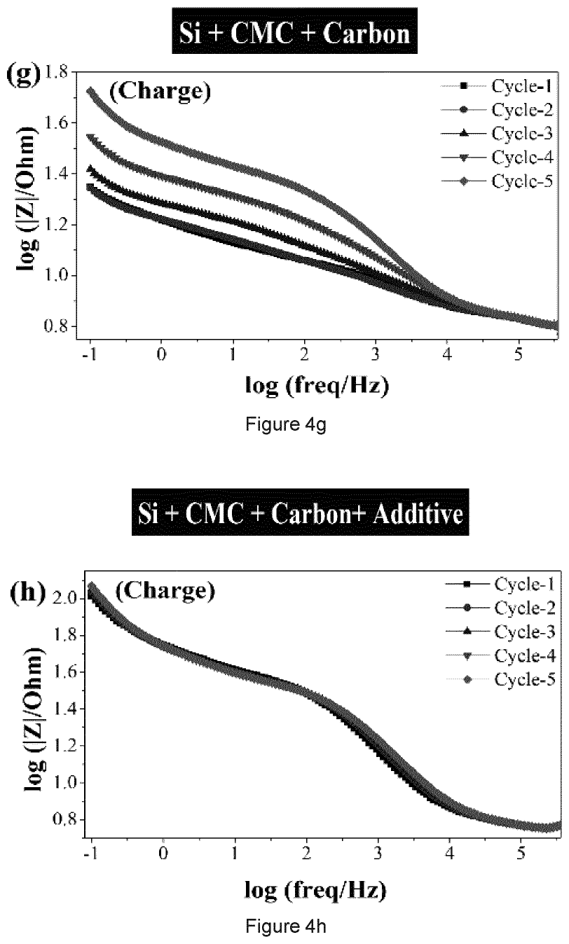

FIGS. 4a-4h show In situ Electrochemical Impedance Spectroscopy data for a silicon anode without an additive and for a silicon anode with a melamine-diborate (MDB) additive.

### Example 1b

The anode and battery of Example 1 with 15 wt % melamine and boric acid in a stoichiometric 1:2 ratio (MLN+HBO) as the additive.

FIG. 3b shows a comparison of the battery's coulombic efficiency vs cycle number for a silicon anode without an additive and for a silicon anode with melamine and boric acid (MLN+HBO) as the additive.

### Example 1c

The anode and battery of Example 1 with 15 wt % melamine (MLN) as the additive. FIG. 3c shows a comparison of the battery's coulombic efficiency vs cycle number for a silicon anode without an additive and for a silicon anode with melamine (MLN) as the additive.

### Example 1d

The anode and battery of Example 1 with 15 wt % 4,6-diamino-2-hydroxy-1,3,5-triazine (ARTZ) as the additive.

FIG. 3d shows a comparison of the battery's coulombic efficiency vs cycle number for a silicon anode without an additive and for a silicon anode with 4,6-diamino-2-hydroxy-1,3,5-triazine (ARTZ) as the additive.

### Example 1e

The and battery of Example 1 with 15 wt % 4-amino-2-hydroxy-1,3,5-triazine (AZCT) as the additive.

FIG. 3e shows a comparison of the battery's coulombic efficiency vs cycle number for a silicon anode without an additive and for a silicon anode with 4-amino-2-hydroxy-1,3,5-triazine (AZCT) as the additive.

FIGS. 3a-3e clearly show an increase in the Coulombic efficiency which results in cell stability in the early cycles (1 to 5) for batteries with additives vs batteries without additives. The batteries with additives reach a stable coulombic efficiency within less than 5 cycles whereas for batteries without an additive, the columbic efficiency stabilizes between 5 and 10 cycles. The electrode without an additive has significant drop in Coulombic efficiency after the first cycles which leads to irreversible charge storage capacity loss.

Table 1 shows battery performance data for the additives of Examples 1a-1e in comparison to the same battery without an additive.

TABLE 1

| | Discharge | Charge | | Capacity | Capacity |
|---|---|---|---|---|---|
| | Capacity | Capacity | | Retention | Retention |
| Example / | after 100 | after 100 | | after 1^{st} | after 5^{th} |
| Additive | cycles | cycles | Efficiency | cycle | cycle |
| Name | (mAh/g) | (mAh/g) | (%) | (%) | (%) |
| 1a / MDB | 2448.24 | 2438.59 | 99.60 | 67.5 | 81.9 |
| 1b / MLN + | 2481.41 | 2466.66 | 99.40 | 74.52 | 86.32 |
| HBO | | | | | |
| 1c / MLN | 2187.33 | 2148.00 | 99.84 | 67.59 | 78.41 |
| 1d / ATRZ | 2305.55 | 2296.82 | 99.62 | 63.98 | 76.75 |
| 1e / AZCT | 1775.83 | 1771.66 | 99.77 | 57.56 | 63.8 |
| No additive | 669.69 | 666.66 | 99.54 | 20.12 | 25.78 |

The results are shown in FIG. 2 which clearly shows the significant improvements in capacity retention over prolonged cycle numbers. After 100 cycles, the batteries with additives show much higher discharge and charge capacities than the battery without an additive. The battery with an MLB+HBO additive has the largest increase whereby the charge and discharge capacities are around 4 times larger than for the battery without an additive.

FIG. 4a-4d show that the SEI formed during lithiation remains intact for the electrode with the additive.

A similar trend can also be observed in Bode's plot of in situ EIS for FIGS. 4e-4f wherein the phase angle shift increases per cycle in the mid-frequency region (2.5-3.5 Hz) for electrodes without an additive, whilst electrodes with an additive remain constant. This confirms that the capacitive part of the interface remains constant during the charge process, and further indicates that the SEI remains stable for electrodes with an additive. The opposite is true for electrodes with an additive; it is thought that continuous SEI formation, or the formation of a thicker SEI, is the reason that the capacitive part of the interface does not remain constant.

The frequency vs. impedance plots (FIGS. 4g-4h) show a continuous increase of cell resistance in both the ionic and mass transport region of the cell in case of silicon electrode without additive while remain constant over five cycles in initial cycles of electrode with additive which allows the high current operation (say C/5) of additive containing electrode and result in better charge storage. This shows that the impact of volume expansion of the silicon particle in electrode and breakdown of the electrolyte can be minimized just in initial three cycles of the cell discharge while the quality of SEI formed over the electrode remain very robust to handle the mechanical and electronic processing of the electrodes.

1. A battery cell comprising
a housing,
a battery core comprising a negative electrode, a positive electrode, and a separator disposed between the negative electrode and the positive electrode,
and an electrolyte operatively disposed between the negative electrode and the positive electrode, the electrolyte comprising at least one lithium salt and a non-aqueous solvent,
wherein the negative electrode comprises
a silicon particle;
a polymeric binder;
a carbonaceous material;
an additive consisting of a compound of formula (I) and optionally boric acid, 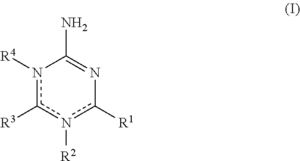
wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

2. The battery according to claim 1 wherein the negative electrode comprises (as wt % solids):
from 40 wt % to 80 wt % silicon particle;
from 5 wt % to 25 wt % polymeric binder;
from 0 wt % to 25 wt % carbonaceous material; and
from 5 wt % to 25 wt % additive consisting of a compound of formula (I) and optionally boric acid.

3. The battery cell of any-preceding-claim 1, wherein the negative electrode comprises (as wt % solids):
from 50 wt % to 70 wt % silicon particle,
from 10 wt % to 20 wt % polymeric binder,
from 5 wt % to 15 wt % carbonaceous material,
from 10 wt % to 20 wt % additive consisting of a compound of formula (I) and optionally boric acid.

4. The battery cell of claim 1, wherein boric acid is present when R¹ and R³ both denote H.

5. The battery cell of claim 1, wherein R³ denotes H or NH₂.

6. The battery cell of claim 1, wherein the additive is selected from:
melamine,
melamine and boric acid in a 1:2 ratio,
melamine diborate,
4,6-diamino-2-hydroxy-1,3,5-triazine, and
4-amino-2-hydroxy-1,3,5-triazine.

7. The battery cell of claim 1, wherein the silicon particle comprises crystalline silicon.

8. The battery cell of claim 1, wherein the silicon particle comprises elemental silicon.

9. The battery cell of claim 1, wherein the polymeric binder comprises carboxymethyl cellulose, particularly a sodium salt of carboxymethyl cellulose.

10. The battery cell of claim 1, wherein the carbonaceous material comprises graphite.

11. The battery cell of claim 1, wherein the electrolyte comprises a non-aqueous solvent mixture selected from:
dimethyl carbonate, ethylene carbonate, and fluoroethylene carbonate;
diethyl carbonate, ethylene carbonate, and fluoroethylene carbonate;
ethylmethyl carbonate, ethylene carbonate, and fluoroethylene carbonate; and
dimethyl carbonate, diethyl carbonate, ethylene carbonate, and fluoroethylene carbonate.

12. The battery cell of claim 1, wherein the lithium salt is selected from the group consisting of include LiClO4, LiAlCl4, LiI, LiBr, LiSCN, LiBF4, LiB(C6H5)4 LiAsF6, LiCF3SO3, LiN(CF3SO2)2, LiN(FSO2)2, LiPF₆, and mixtures thereof.

13. The battery cell of claim 12, wherein the lithium salt comprises LiPF₆.

14. The battery cell of claim 1, wherein the cathode comprises lithium cobalt oxide, lithium manganese oxide, lithium iron phosphate, lithium nickel manganese cobalt oxide, or lithium nickel cobalt aluminium oxide.

15. The battery cell of claim 1, wherein the separator comprises a cellulose or a polyolefin.

16. The battery cell of claim 1, wherein the battery cell has a charge capacity after 100 cycles of at least 1500 mAh/g.

17. The battery cell of claim 1, wherein the battery cell has a charge capacity after 100 cycles of at least 2150 mAh/g.

18. The battery cell of claim 1, wherein the negative electrode comprises (as wt % solids):
from 40 wt % to 80 wt % silicon particle;
from 5 wt % to 25 wt % polymeric binder;
from 0 wt % to 25 wt % carbonaceous material; and
from 7 wt % to 25 wt % additive consisting of a compound of formula (I) and optionally boric acid.

19. An electronic device containing the battery cell of claim 1.

20. The electronic device of claim 19, wherein the device is a portable electronic appliance such as a mobile phone.

21. The device of claim 19, wherein the device is an electric vehicle.

22. A composition comprising:
a silicon particle;
a polymeric binder;
optionally a carbonaceous material; and
an additive consisting of a compound of formula (I) and optionally boric acid, 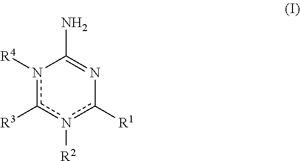
wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

23. An electrode comprising a composition comprising:
a silicon particle;
a polymeric binder;
optionally a carbonaceous material; and
an additive consisting a compound of formula (I) and optionally boric acid, 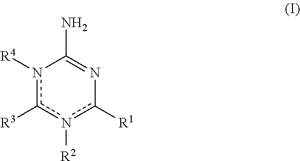
wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

24. Use of a compound of formula (I), optionally present together with boric acid, for improving the SEI stability of a silicon electrode in a lithium ion battery 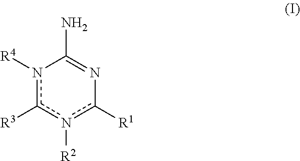
wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.

25. Use of a compound of formula (I), optionally present together with boric acid, for preventing continued growth and/or thickening of the SEI of a silicon electrode in a lithium ion battery. 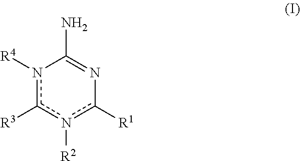
wherein
R¹ denotes H, NH₂, OH or ═O;
R² is absent or denotes H when R¹ denotes ═O;
R³ denotes H, NH₂, OH or ═O; and
R⁴ is absent or denotes H when R³ denotes ═O; and
wherein the compound of formula (I) may optionally be present together with boric acid, provided that when boric acid is present neither R¹ nor R³ denotes OH or ═O.
